(19) United States
(12) Patent Application Publication
(10) Pub. No.: US 2025/0269794 A1
(43) Pub. Date: Aug. 28, 2025

(54) UTV Side Mirror Device

(71) Applicant: Chris Davis, Sheboygan, WI (US)

(72) Inventor: Chris Davis, Sheboygan, WI (US)

(21) Appl. No.: 19/010,320

(22) Filed: Jan. 6, 2025

Related U.S. Application Data
(60) Provisional application No. 63/556,544, filed on Feb. 22, 2024.

(51) Int. Cl. B60R 1/06

(52) U.S. Cl. CPC B60R 1/0602

(57) ABSTRACT

A UTV side mirror device is provided. The device is comprised of a side mirror device for Utility Terrain Vehicles (UTVs), designed to improve visibility and safety by providing a securely mounted, adjustable mirror system that withstands the stresses of off-road conditions. The device comprises a durable mounting bracket attachable to the UTV's exterior, ideally on the A-pillar, with at least one pivotable mounting arm that enables adjustable positioning. The mounting arm connects to the bracket via a locking pivot point that allows forward and backward movement, essential for clearing rear-hinged doors. The arm is typically L-shaped, extending away from the vehicle for optimal viewing, and connects to a second pivot point that supports the mirror, allowing additional rotational adjustments. Locking mechanisms at each pivot point ensure stability, even under vibrations.

### CROSS-REFERENCE TO RELATED APPLICATION

The present application claims priority to, and the benefit of, U.S. Provisional Application No. 63/556,544, which was filed on Feb. 22, 2024, and is incorporated herein by reference in its entirety.

### FIELD OF THE INVENTION

The present invention relates generally to the field of utility task vehicles. More specifically, the present invention relates to an adjustable side mirror device for UTVs, comprising a mounting bracket and pivoting arm that provides secure, customizable positioning for a side view mirror. Accordingly, the present disclosure makes specific reference thereto. Nonetheless, it is to be appreciated that aspects of the present invention are also equally applicable to other like applications, devices, and methods of manufacture.

### BACKGROUND

Utility Task Vehicles (UTVs) are utilized extensively in outdoor environments, including agricultural, construction, and recreational settings, where their off-road capabilities and versatility make them ideal for various tasks. These vehicles are often driven in rugged terrains and populated areas where maneuverability and awareness of surroundings are essential to avoid collisions with obstacles, other vehicles, or pedestrians. However, unlike conventional on-road vehicles, UTVs typically lack side or rear-view mirrors, which significantly limits the driver's ability to monitor areas directly behind and to the sides of the vehicle. This lack of built-in mirrors requires drivers to physically turn their heads or shift their bodies to check their surroundings, a movement that diverts attention from the forward path. This limitation can pose serious safety risks, particularly when operating in environments with uneven terrain or other vehicles, as distractions can easily lead to collisions or accidents.

Moreover, the structural design of many UTVs includes open frames or specialized door configurations, such as rear-hinged doors, which can further complicate visibility for drivers. In certain models, door placement or lack of side enclosures can prevent traditional mirrors from attaching securely or obstruct mirror placement entirely. This lack of visibility not only endangers the UTV operator but can also compromise the safety of others nearby, as the driver's reduced field of vision increases the likelihood of missing pedestrians or unexpected obstacles. Given the diverse and often hazardous conditions in which UTVs operate, providing drivers with an enhanced field of vision that allows them to monitor their surroundings without diverting attention from the road ahead is essential for ensuring safe vehicle operation. There is a clear need for a specialized side mirror device that not only improves visibility but also adapts to the unique framework and door design of UTVs.

Therefore, there exists a long-felt need in the art for a UTV side mirror device that enables drivers to maintain visual awareness of the areas behind and beside the vehicle without having to turn away from the road ahead. There also exists a long-felt need in the art for a UTV side mirror device that attaches securely to the vehicle's external structure, ensuring stability and durability across varied terrain. Moreover, there exists a long-felt need in the art for a UTV side mirror device that can pivot forward and backward to accommodate UTV models with rear-hinged doors, enhancing the device's versatility across different UTV designs.

The subject matter disclosed and claimed herein, in one embodiment thereof, comprises a UTV side mirror device. The device is comprised of a side mirror device for Utility Terrain Vehicles (UTVs), designed to improve visibility and safety by providing a securely mounted, adjustable mirror system that withstands the stresses of off-road conditions. The device comprises a durable mounting bracket attachable to the UTV's exterior, ideally on the A-pillar, with at least one pivotable mounting arm that enables adjustable positioning. The mounting arm connects to the bracket via a locking pivot point that allows forward and backward movement, essential for clearing rear-hinged doors. The arm is typically L-shaped, extending away from the vehicle for optimal viewing, and connects to a second pivot point that supports the mirror, allowing additional rotational adjustments. Locking mechanisms at each pivot point ensure stability, even under vibrations. The mirror itself can be convex or concave, with optional heating elements to prevent fogging, powered by a dedicated source or the UTV's electrical system. In use, the device facilitates flexible mirror positioning for entry and repositions to standard alignment post-entry, maximizing visibility and convenience for UTV drivers.

In this manner, the UTV side mirror device of the present invention accomplishes all the forgoing objectives and provides a side mirror specifically designed for UTV applications. This device attaches securely to both sides of the UTV using robust steel brackets, ensuring a stable and enduring connection even in demanding off-road conditions. Its pivoting feature allows the mirrors to move forward and backward, accommodating UTVs with rear-hinged doors without obstructing access. By enabling drivers to view their surroundings without diverting attention from the road, the UTV side mirror device enhances situational awareness and operational safety, providing a reliable solution for reducing potential accidents and supporting safer UTV navigation.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a UTV side mirror device. The device is a side mirror assembly for UTVs, designed to enhance visibility and safety by securely mounting to the UTV's exterior frame. The device comprises a durable mounting bracket, which attaches to the UTV's A-pillar or other stable exterior points, using at least one fastener like a bolt or clamp, ensuring reliable attachment under off-road conditions.

The device includes a first mounting arm connected to the bracket via a first pivot point, allowing rotational adjustment. The first pivot point may be a hinge, ball-and-socket joint, or bolt, providing either fixed or multi-directional movement, depending on the desired positioning. A locking mechanism, such as a ratchet or friction lock, secures the arm in place to prevent movement from vibrations.

The mounting arm, preferably L-shaped for optimal visibility, can also be straight or telescoping to accommodate driver preferences. A second pivot point at the distal end of the arm connects the mirror, enabling up to 90 degrees of rotational adjustment along horizontal or vertical axes. This second pivot may also feature a locking mechanism to maintain the mirror's position during use.

The mirror can be concave or convex, catering to specific visibility needs, and may include a heating element to prevent fogging, powered by a battery or the UTV's electrical system. The heating element is activated by a button on the mirror.

The first pivot enables the arm to swing forward, allowing rear-hinged UTV doors to open without obstruction. The second pivot allows precise mirror adjustment to the driver's preferred angle for optimal visibility.

The method of using the side mirror device includes securing the bracket to the UTV's frame, positioning the arm to allow door clearance, closing the door, and adjusting the arm and mirror to the desired positions for effective side viewing. The mirror is then locked into place to maintain alignment during operation.

Accordingly, the UTV side mirror device of the present invention is particularly advantageous as it provides a side mirror specifically designed for UTV applications. This device attaches securely to both sides of the UTV using robust steel brackets, ensuring a stable and enduring connection even in demanding off-road conditions. Its pivoting feature allows the mirrors to move forward and backward, accommodating UTVs with rear-hinged doors without obstructing access. By enabling drivers to view their surroundings without diverting attention from the road, the UTV side mirror device enhances situational awareness and operational safety, providing a reliable solution for reducing potential accidents and supporting safer UTV navigation.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a UTV side mirror device of the present invention in accordance with the disclosed architecture;

FIG. 2 illustrates a perspective view of one potential embodiment of a UTV side mirror device of the present invention in accordance with the disclosed architecture; and

FIG. 3 illustrates a flowchart of a method of using one potential embodiment of a UTV side mirror device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a UTV side mirror device that enables drivers to maintain visual awareness of the areas behind and beside the vehicle without having to turn away from the road ahead. There also exists a long-felt need in the art for a UTV side mirror device that attaches securely to the vehicle's external structure, ensuring stability and durability across varied terrain. Moreover, there exists a long-felt need in the art for a UTV side mirror device that can pivot forward and backward to accommodate UTV models with rear-hinged doors, enhancing the device's versatility across different UTV designs.

The present invention, in one exemplary embodiment, is comprised of a UTV side mirror device. The device is a side mirror assembly for UTVs, designed to improve visibility and safety by securely mounting to the UTV's exterior frame. It includes a durable mounting bracket that attaches to the UTV's A-pillar or other stable exterior points with at least one fastener, such as a bolt or clamp, ensuring secure attachment under off-road conditions.

The assembly includes a first mounting arm connected to the bracket via a first pivot point, allowing rotational adjustment. This pivot point may be a hinge, ball-and-socket joint, or bolt, providing either fixed or multi-directional movement, depending on positioning needs. A locking mechanism, such as a ratchet or friction lock, stabilizes the arm to prevent movement due to vibrations.

The mounting arm, ideally L-shaped for enhanced visibility, may also be straight or telescoping to suit driver preferences. A second pivot point at the arm's distal end connects the mirror, enabling up to 90 degrees of rotational adjustment along horizontal or vertical axes. This second pivot may also include a locking mechanism to hold the mirror's position during use.

The mirror can be concave or convex to meet specific visibility requirements and may include a heating element to prevent fogging, powered by a battery or the UTV's electrical system. The heating element is activated by a button on the mirror.

The first pivot allows the arm to swing forward, providing clearance for rear-hinged UTV doors. The second pivot enables precise mirror adjustment to the driver's preferred angle for optimal visibility.

The method for using the side mirror device involves securing the bracket to the UTV's frame, positioning the arm for door clearance, closing the door, and adjusting the arm and mirror for optimal side viewing. The mirror is then locked into place to maintain alignment.

The UTV side mirror device is particularly advantageous as a mirror designed specifically for UTV use. It attaches securely to both sides of the UTV with robust steel brackets, ensuring a stable connection under demanding off-road conditions. The pivoting feature allows mirror adjustment for UTVs with rear-hinged doors without obstructing access. By allowing drivers to view their surroundings without diverting focus, the device enhances situational awareness and operational safety, providing a reliable solution for reducing accidents and supporting safer UTV navigation.

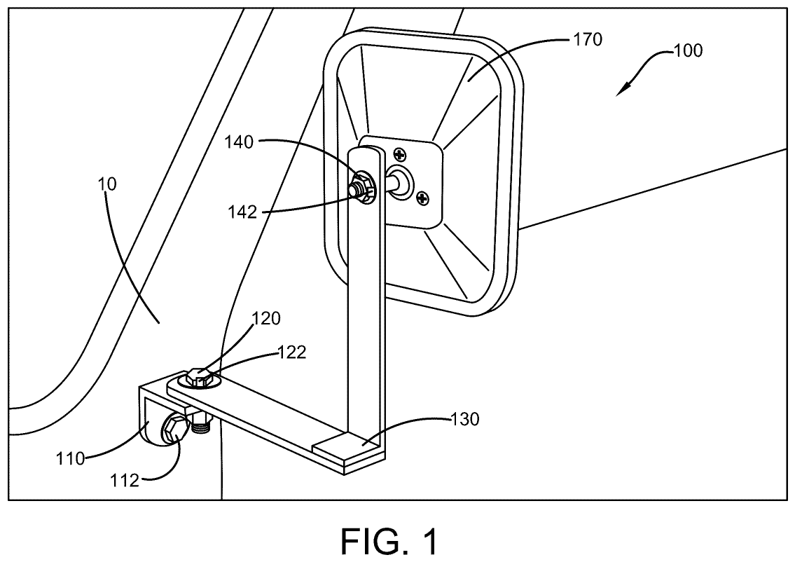

Referring initially to the drawings, FIG. 1 illustrates a perspective view of one potential embodiment of a UTV side mirror device 100 of the present invention in accordance with the disclosed architecture. The device 100 is comprised of a side mirror for use with a UTV. The device is designed to improve visibility and safety for UTV drivers by providing a side mirror that can be securely mounted to the exterior frame of a UTV. More specifically, the device 100 is comprised of a mounting bracket 110, which is constructed from durable materials, such as steel, to withstand the stresses of off-road use, including vibrations, impacts, and exposure to various weather conditions. The mounting bracket 110 is preferably attached to the A-pillar 10 of a UTV but may also be mounted at alternative points on the vehicle's exterior if that location provides optimal viewing angles or stability. The bracket 110 attaches to the UTV via at least one fastener 112, such as a bolt, through screws, rivets, clamps, etc.

Connected to the mounting bracket 110 is at least one first mounting arm 130. This arm 130 attaches to the bracket 110 via a first pivot point 120, which allows for adjustable positioning of the arm 130 relative to the bracket 110. The first pivot point 120 may be various types of pivot points that allow for rotational movement, including a hinge, a ball-and-socket joint, or a bolt. A hinge at the pivot point 120 provides a fixed axis of rotation, ideal for controlled forward and backward movement. A ball-and-socket joint offers more flexible, multi-directional movement, allowing the arm 130 to be adjusted along multiple angles. Alternatively, a bolt used at the pivot can serve as a basic pivot mechanism with adjustable tightness to allow the arm 130 to rotate.

The first pivot point 120 is ideally a locking pivot, which can secure the arm 130 in a desired position, ensuring that it remains stable during operation via at least one locking mechanism 122. Locking mechanisms 122 may include a ratcheting mechanism, which allows the arm 130 to lock into preset angles, or a friction lock, where adjustable tension maintains the arm's 130 position even in the face of heavy vibrations. A compression joint may also be used, providing a clamp-like effect to hold the arm 130 steady once positioned.

The mounting arm 130 is preferably L-shaped to allow the mirror to extend away from the vehicle body for improved visibility. However, it may also be designed in alternative shapes, such as straight or telescoping configurations, to further customize the viewing angle based on vehicle specifications and driver preference. At the distal end of the mounting arm 130, a second pivot point 140 connects at least one mirror 170 to the arm. Like the first pivot point 120, the second pivot point 140 enables rotation of the mirror 170 relative to the arm 130 along at least 90 degrees on either a horizontal or vertical axis of the same, providing additional customization in positioning. The second pivot point 140 may also employ a hinge, ball-and-socket joint, or bolt, allowing the mirror to be tilted and adjusted independently of the arm's position. A locking mechanism 142 at the second pivot 140, similar to those used at the first pivot 120, can hold the mirror 170 securely in place once adjusted, allowing the user to set the mirror's 170 angle and maintain it under operational stresses.

The mirror 170 attached to the second pivot point 140 may be concave or convex, depending on the driver's preference and specific visibility needs. Concave mirrors provide a focused view for closer observation, while convex mirrors offer a wider field of view to capture a broader surrounding area. In certain embodiments, the mirror 170 includes at least one heating element 172 that prevents fogging or ice formation, thereby maintaining visibility in adverse weather conditions. The heating element 172 is powered by a power source 174, which may include a rechargeable battery, disposable battery, or solar panel, though it may also be wired directly into the UTV's electrical system for continuous operation. The heating element 172 may be activated by at least one button 176 on the mirror 170.

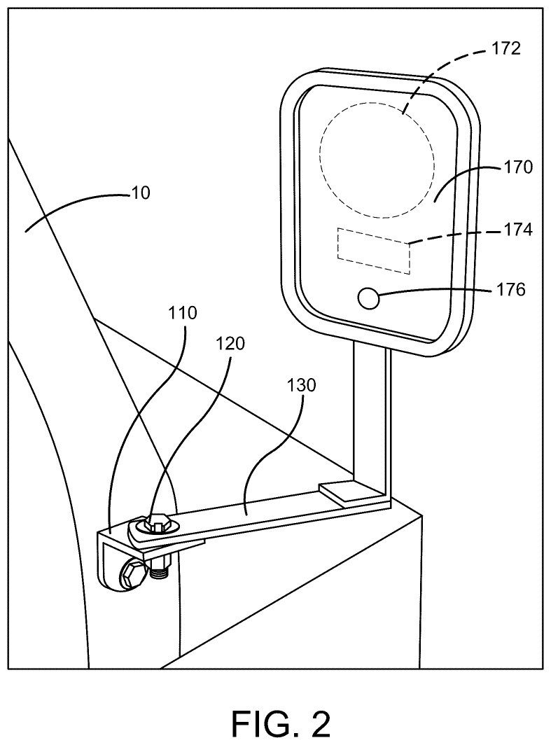

During use, the first pivot point 120 allows the arm 130 to swing forward as seen in FIG. 2, which is particularly useful for UTVs with rear-hinged doors, as it permits the arm and mirror to be moved out of the way to provide clear door access. The second pivot point 140, meanwhile, allows the mirror to be positioned precisely to the driver's preferred viewing angle, ensuring optimal visibility for safe operation, as seen in FIG. 1.

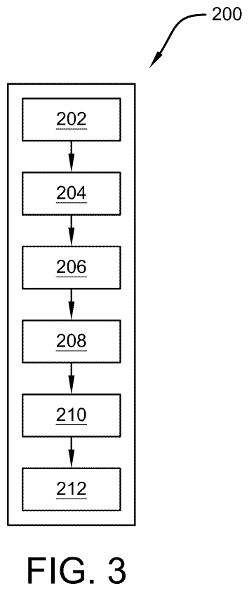

The present invention is also comprised of a method of using 200 the side mirror device 100, as illustrated in FIG. 3. First, a side mirror device 100 is provided, the device 100 being comprised of a mounting bracket 110, at least one mounting arm 130, and at least one mirror 170 [Step 202]. Then, the mounting bracket 110 is securely attached to an exterior frame of the UTV, such as the A-pillar 10, via at least one fastener 112, such as a bolt or screw [Step 204]. Next, the first mounting arm 130 is adjusted by rotating it around a first pivot point 120 to achieve a preliminary position in front of a UTV door (as seen in FIG. 2) that allows the door to open [Step 206]. Next, a user can step into the UTV through the door and close the door [Step 208]. Then, the user can rotate the first mounting arm 130 closer to the door once the door has been closed, bringing the mirror 170 into the standard position for a side view mirror of a vehicle as seen in FIG. 1 (i.e., in line with the door) [Step 210]. Finally, the mirror 170 can be adjusted and locked into position via a second pivot point 140 [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “UTV side mirror device” and “device” are interchangeable and refer to the UTV side mirror device 100 of the present invention.

Notwithstanding the forgoing, the UTV side mirror device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the UTV side mirror device 100 as shown in the FIGS. are for illustrative purposes only, and that many other sizes and shapes of the UTV side mirror device 100 are well within the scope of the present disclosure. Although the dimensions of the UTV side mirror device 100 are important design parameters for user convenience, the UTV side mirror device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A UTV side mirror device comprising:
a mounting bracket;
a mounting arm connected to the mounting bracket via a first pivot point, the first pivot point enabling horizontal rotational adjustment of the mounting arm relative to the mounting bracket; and
a mirror connected to the mounting arm via a second pivot point, the second pivot point enabling vertical and horizontal rotational adjustment of the mirror relative to the mounting arm.

2. The UTV side mirror device of claim 1, wherein the first pivot point is comprised of a hinge, a ball-and-socket joint, or a bolt.

3. The UTV side mirror device of claim 1, wherein the second pivot point is comprised of a hinge, a ball-and-socket joint, or a bolt.

4. The UTV side mirror device of claim 1, wherein the mirror is comprised of a concave mirror.

5. The UTV side mirror device of claim 1, wherein the first pivot point is comprised of a first locking mechanism.

6. The UTV side mirror device of claim 1, wherein the second pivot point is comprised of a second locking mechanism.

7. The UTV side mirror device of claim 1, wherein the mirror is comprised of a heating element.

8. The UTV side mirror device of claim 7, wherein the heating element is comprised of a rechargeable battery.

9. A UTV side mirror device comprising:
a mounting bracket;
a mounting arm connected to the mounting bracket via a first pivot point, the first pivot point enabling horizontal rotational adjustment of the mounting arm relative to the mounting bracket; and
a mirror connected to the mounting arm via a second pivot point, the second pivot point enabling vertical and horizontal rotational adjustment of the mirror relative to the mounting arm;
a heating element positioned on the mirror; and
a button positioned on the mirror, the button configured to activate the heating element.

10. The UTV side mirror device of claim 9, wherein the mirror is comprised of a convex mirror.

11. The UTV side mirror device of claim 9, wherein the first pivot point is comprised of a first locking mechanism.

12. The UTV side mirror device of claim 11, wherein the first locking mechanism is comprised of a friction lock, a compression joint, a locking pivot, or a ratcheting mechanism.

13. The UTV side mirror device of claim 9, wherein the second pivot point is comprised of a second locking mechanism.

14. The UTV side mirror device of claim 13, wherein the second locking mechanism is comprised of a friction lock, a compression joint, a locking pivot, or a ratcheting mechanism.

15. The UTV side mirror device of claim 9, wherein the mounting arm is comprised of a telescopic mounting arm.

16. The UTV side mirror device of claim 9, wherein the mounting bracket is comprised of a fastener.

17. The UTV side mirror device of claim 16, wherein the fastener is comprised of a bolt.

18. A method of using a UTV side mirror device, the method comprising the following steps:
providing a UTV side mirror device comprised of a mounting bracket, a mounting arm, and a mirror;
attaching the mounting bracket to an exterior frame of the UTV via a fastener;
adjusting the mounting arm by rotating the mounting arm around a first pivot point to achieve a preliminary position that allows a door of a UTV to open;
repositioning the mounting arm closer to the door after the door is closed to align the mirror with a standard side view mirror position; and
adjusting and locking the mirror into a desired viewing angle via a second pivot point.

19. The method of using a UTV side mirror device of claim 18, wherein the first pivot point is comprised of a hinge, a ball-and-socket joint, or a bolt.

20. The method of using a UTV side mirror device of claim 18, wherein the second pivot point is comprised of a hinge, a ball-and-socket joint, or a bolt.
